(19) United States
(12) Patent Application Publication
(10) Pub. No.: US 2009/0125502 A1
(43) Pub. Date: May 14, 2009

(54) SYSTEM AND METHODS FOR GENERATING DIVERSIFIED VERTICAL SEARCH LISTINGS

(75) Inventors: Chyr-Chong Ting, San Jose, CA (US); Minos Garofalakis, San Francisco, CA (US); Erik Nathan Vee, San Jose, CA (US); Jayavel Shanmugasudaram, Santa Clara, CA (US); Rajagopal Baskaran, Santa Clara, CA (US); Yuan Zhuge, Mountain View, CA (US); Jagadish Prasad Samantarai, Fremont, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/938,962

(22) Filed: Nov. 13, 2007

(51) Int. Cl. G06F 7/10; G06F 17/30

(52) U.S. Cl. 707/5; 707/E17.017

(57) ABSTRACT

A method of generating a diversified vertical search results listing, including listing attribute values related to search criteria and their frequency of occurrence to create a plurality of listings; creating a plurality of interval bands based on the plurality of listings; generating a random diversity score for each listing over a substantially uniform distribution within each of the plurality of bands; and sorting a set of search results for diversified listing in response to a user searching for the search criteria according to the diversity score of each listing.

### BACKGROUND

1. Technical Field

The disclosed embodiments relate generally to the field of online searching, and more particularly, to a system and method for generating diversified vertical search listings.

2. Related Art

The present embodiments related generally to the field of online searching over a network such as the Internet. More particularly, the present embodiments relate to the field of vertical search of a database available on line.

Vertical search involves queries over a set of attributes which may or may not involve keywords. When a keyword is specified, the results will be ordered based on keyword match in the body of text within the title, text description, and other fields. The returned result set will be based on relevancy based on the matching text as well as assigned relevancy weights of other fields at the creation or modification time of the listing. Another form of search involves querying over a set of attributes without specifying a keyword. For example, in a vertical search engine for automobiles, the user interface may expose the model and make of the car as queryable attributes.

When a searching user makes a query, typical search results are returned based on pure relevancy. For example, a query for “Acura” may return:

TABLE 1

| | | | |
|---|---|---|---|
| 2008 | Acura | RL | $45,000 |
| 2007 | Acura | MDX | $47,000 |
| 2007 | Acura | MDX | $48,000 |
| 2007 | Acura | MDX | $49,000 |

Another way to present the results, however, is through a “diversified” result set.

TABLE 2

| | | | |
|---|---|---|---|
| 2008 | Acura | RL | $45,000 |
| 2007 | Acura | MDS | $47,000 |
| 2007 | Acura | MRL | $33,000 |
| 2007 | Acura | TSX | $28,000 |

Note that Table 2 includes a variety of Acura models with differing price ranges, thus resulting in a more diverse set of results for a query for “Acura.” The diversified set of results provides the user a better view of the different combinations of attribute values.

In typical diversity search implementations, the search will involve multiple queries across the different combinations of a set of attribute values. In the above example, if Acura has 20 different models, the search will need to separately query over each of the 20 different models. There may be other methods to implement a diversified search at the time of the query, but any implementation will involve substantially more processing time for the query processor. This is at least due to the multiple required queries of the different combinations of attribute values.

### SUMMARY

By way of introduction, the embodiments described below are drawn to systems and methods for online searching, and more particularly, the present embodiments relate to the systems and methods for generating diversified vertical search listings.

In a first aspect, a method is disclosed for generating a diversified vertical search results listing, including listing attribute values related to search criteria and their frequency of occurrence to create a plurality of listings; creating a plurality of interval bands based on the plurality of listings; generating a random diversity score for each listing over a substantially uniform distribution within each of the plurality of bands; and sorting a set of search results for diversified listing in response to a user searching for the search criteria according to the diversity score of each listing.

In a second aspect, a method is disclosed for generating a diversified vertical search results listing, including creating a table to list attribute values related to search criteria and their frequency of occurrence for an attribute of interest; creating a plurality of interval bands based on a plurality of listings in the table; generating a random diversity score for each listing over a substantially uniform distribution within each of the plurality of bands; and incorporating an additional relevancy factor into the generated diversity scores through determining a relevancy score for the additional relevancy factor over each of the plurality of bands, and combining the relevancy score for the additional relevancy factor with the diversity score in each respective band to generate a plurality of calculated final diversity scores across the plurality of bands. The method also includes sorting a set of search results for diversified listing in response to a user searching for the search criteria according to the final diversity score of each listing.

In a third aspect, a system is disclosed for generating a diversified vertical search results listing, including a vertical search engine to process queries from a web site and to return results based on calculated relevancy scores. A database is to store statistical data on attribute values associated with attributes of interest related to the queries, and to store listings on the attributes of interest and corresponding descriptive text. A diversity processing engine is coupled with the vertical search engine and with the database, wherein the diversity processing engine incorporates listings statistics from the database to calculate diversity scores that produce a diversified set of listings for at least some of the attributes of interest. The diversity processing engine: creates a table for listing attribute values related to search criteria and their frequency of occurrence; creates a plurality of bands based on a plurality of listings in the table; generates a random diversity score for each listing over a substantially uniform distribution within each of the plurality of bands; and sorts a set of search results for diversified listing of the attribute of interest according to the diversity score of each respective listing.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a diagram of a system for generating diversified vertical search listings.

FIG. 2 is a flow chart of a method for generating diversified vertical search listings.

FIG. 3 is a flow chart of a method for generating diversified vertical search listings when additional relevancy factors are incorporated.

### DETAILED DESCRIPTION

In the following description, numerous specific details of programming, software modules, user selections, network transactions, database queries, database structures, etc., are provided for a thorough understanding of various embodiments of the systems and methods disclosed herein. However, the disclosed system and methods can be practiced with other methods, components, materials, etc., or can be practiced without one or more of the specific details. In some cases, well-known structures, materials, or operations are not shown or described in detail. Furthermore, the described features, structures, or characteristics may be combined in any suitable manner in one or more embodiments. The components of the embodiments as generally described and illustrated in the Figures herein could be arranged and designed in a wide variety of different configurations.

The order of the steps or actions of the methods described in connection with the disclosed embodiments may be changed as would be apparent to those skilled in the art. Thus, any order appearing in the Figures, such as in flow charts, or in the Detailed Description is for illustrative purposes only and is not meant to imply a required order.

Several aspects of the embodiments described are illustrated as software modules or components. As used herein, a software module or component may include any type of computer instruction or computer executable code located within a memory device and/or transmitted as electronic signals over a system bus or wired or wireless network. A software module may, for instance, include one or more physical or logical blocks of computer instructions, which may be organized as a routine, program, object, component, data structure, etc. that performs one or more tasks or implements particular abstract data types.

In certain embodiments, a particular software module may include disparate instructions stored in different locations of a memory device, which together implement the described functionality of the module. Indeed, a module may include a single instruction or many instructions, and it may be distributed over several different code segments, among different programs, and across several memory devices. In some embodiments, modules may be combined within an integrated set of instructions. Some embodiments may be practiced in a distributed computing environment where tasks are performed by a remote processing device linked through a communications network. In a distributed computing environment, software modules may be located in local and/or remote memory storage devices.

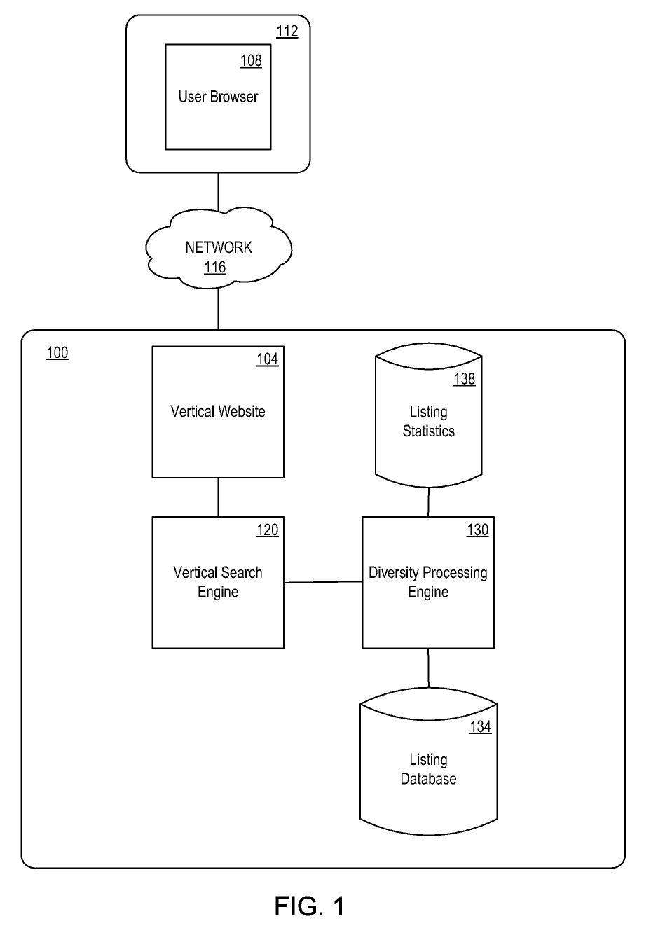

FIG. 1 is a diagram of a system 100 for generating diversified vertical search listings. The system 100 includes a vertical website 104 that is made available in a user browser 108 of a computer 112 of a searching user. The computer 112 may include a cell phone, a personal digital assistant, a mini computer, or any other device capable of connecting over a network 116 to communicate with the system 100. The network 116 may include a local area network (LAN), a wide area network (WAN), the Internet (e.g., the World Wide Web), an extranet, or a combination of the same, including a variety of ways to connect to the network 116 as are known in the art.

When “vertical” is referred to herein reference is made to any source of data focused on specific attributes made available through searching or selective browsing. As described above, vertical search involves queries over a set of attributes which may or may not involve keywords. Where keywords need not be specified, a user interface (not shown) through the vertical website 104 exposes queryable attributes in which browsing users would likely be interested, e.g., a make and model of an automobile on an auto vertical site.

The system 100, accordingly, further includes a vertical search engine 120 that processes queries from the vertical website 104 and returns results based on calculated relevancy scores. Vertical search engines enable what has been referred to as “specialized search,” which includes “local,” “topical,” and “vertical” searches. This disclosure is intended to relate to all types of specialized searches in which an individual or entity may be looking for something specific, e.g., information related to an area of special interest.

Oftentimes vertical searches engines are sought out because they offer more targeted results to a specific area (or attribute) of interest when compared with general search engines that generate exhaustive returns of information. General search engines will often push into top positions sponsored results paid for by advertisers that are not necessarily very relevant to the queried terms. In contrast, advertisers who advertise on a vertical search engine (120) reach a focused audience of users that have particular interests in certain search criteria or attributes. General search engines also use algorithms that often produce many nearly (or completely) irrelevant results for a query that a user must sift through. Such algorithms include those employed by a Web crawler that works like a spider to find websites with purported relevancy to the search terms. Providing diversified results by the vertical search engine 120 is desired as a way to give a variety of options on a first (and subsequent) page of search results to a searching user in lieu of forcing the user to look at further pages (sometimes deep) within the search results to find a variety of combinations of attribute values that may be sought.

The system 100 further includes a diversity processing engine 130 that is coupled with the vertical search engine 120. The diversity processing engine 130 is also coupled with a listing database 134 and a listing statistics database 138. Herein, the phrase “coupled with” is defined to mean directly connected to or indirectly connected through one or more intermediate components. Such intermediate components may include both hardware and software based components. Note that the listing and listings statistics database 134, 138 may be combined logically and/or physically in addition to being distributed across the network 116 in varying degrees. Attribute values are scanned for across the listings in the listing database 134 to generate statistical information for storage in the listing statistics database 138. The diversity processing engine 130 uses the listings' statistics to calculate relevancy scores that will produce diversity in search results, e.g., the retuned result set becomes diverse when sorted based on the relevancy score.

The diversity processing engine 130 may generate diversified listings in advance of receiving a query from a user through the user browser 108, and thereby increase the speed at which diversified search results are returned upon reception of the query. Accordingly, the diversity processing engine 130 may use the statistical data in the listing statistics database 138 on attribute values that relate to potential queries to produce and store diversified listings in the listing database 134. While it may be preferred to do the processing and thus generate the diversity listings of search results in advance of receiving a query, this disclosure should not be confined thereto, but expansively includes processing diversity listings at the time of query.

The following is but one example of how the diversity processing engine 130 functions to produce diversity search listings for delivery in response to search queries. The example continues with the “Acura” example above, but now the diversity processing engine 130 preprocesses listings for the Acura make attribute over the model attribute for search criteria including “Acura.”

First, the listings database 134 is scanned and a table is created for the attribute values over the attribute of interest (model) and the number of listings for the particular attribute value. Table 3 below shows such a table for the listing attribute values (make and model) related to search criteria (Acura) and their frequency of occurrence.

TABLE 3

| Make | Model | Frequency |
|---|---|---|
| Acura | RL | 100 |
| Acura | MDS | 400 |
| Acura | RL | 500 |
| Acura | TSX | 1000 |

Based on percentage of frequency, the results of Table 3 can be recast as shown in Table 4.

TABLE 4

| Make | Model | Percentage |
|---|---|---|
| Acura | RL | 5% |
| Acura | MDS | 20% |
| Acura | RL | 25% |
| Acura | TSX | 50% |

There may or may not be additional attributes influencing overall relevancy. The case where there are no additional attributes will first be covered. Next, Table 5 shows four bands that are created for the four attribute values listed in Tables 3 and 4.

TABLE 5

| Make | Model | Band |
|---|---|---|
| Acura | RL | 0-0.05 |
| Acura | MDS | 0-0.20 |
| Acura | RL | 0-0.25 |
| Acura | TSX | 0-0.50 |

The Acura RL listings will be scattered within the 0-0.5 band. Since there are fewer Acura RL listings, the idea is to scatter within a proportionally smaller interval so they will appear with equal probability on the first search result page as with the other models. This can be done by generating a random relevancy score over a uniform distribution within the 0-0.05 band. The process is continued for all the remaining three bands. The net result is that there will be relevancy scores assigned to all listings related to the four attribute values that can be used as a sort parameter. When the results are sorted according to this parameter, there will be a high probability of returning diverse search results.

In the case where there are other relevancy factors involved, the relevancy score can be folded into the diversity relevancy score. Other possible relevancy factors are vast in number and may include, for instance, a click through rate (CTR), a brand popularity metric, a historic level of consumption, etc. For example, the listings across the Acura RL may have CTR scores between 0-1 and it is desired to also rank by CTR scores. Table 6 shows the above listings according to CRT scores.

TABLE 6

| Make | Model | CTR Score |
|---|---|---|
| Acura | RL | 0.02 |
| Acura | MDS | 0.01 |
| Acura | RL | 0.03 |
| Acura | TSX | 0.04 |

If the CRT scores are spread out more or less uniform across the plurality of bands, then the CRT scores in each band may be combined with respective diversity relevancy scores across the plurality of bands to result a new set of diversity scores. This new set of diversity scores are then available for sorting by the diversity processing engine 130 to create a diverse set of results. If, however, the CRT scores are not uniformly distributed throughout the interval bands, the CTR scores need to be mapped based on the probability of occurrence to a new score that will be within the bands described above. A histogram is first generated for the CTR score per frequency of score, an example of which is shown in Table 7.

TABLE 7

| CTR | Frequency |
|---|---|
| 0-0.01 | 40 |
| 0.01-0.02 | 50 |
| 0.02-1.0 | 10 |

For example, the first listing in Table 6 has a 0.02 CTR score which means that it falls in the top 90%. The new relevancy score would be 0.90×(1−0.05) assuming higher scores are more relevant. Each listing in Table 6 would undergo a similar mapping function to create new relevancy scores across each listing. Once new relevancy scores for each listing is calculated in the histogram through this a mapping function, the histogram may be folded into the table created with diversity scores to create revised diversity scores that will then be used to sort the set of search results to return a diversified version thereof.

If there are more attributes that are considered, the histogram can be generated over the additional attribute combinations and a final score is calculated in the same manner. The calculations and score relevancy can be done in real-time. For real-time applications, the statistics are updated in real-time.

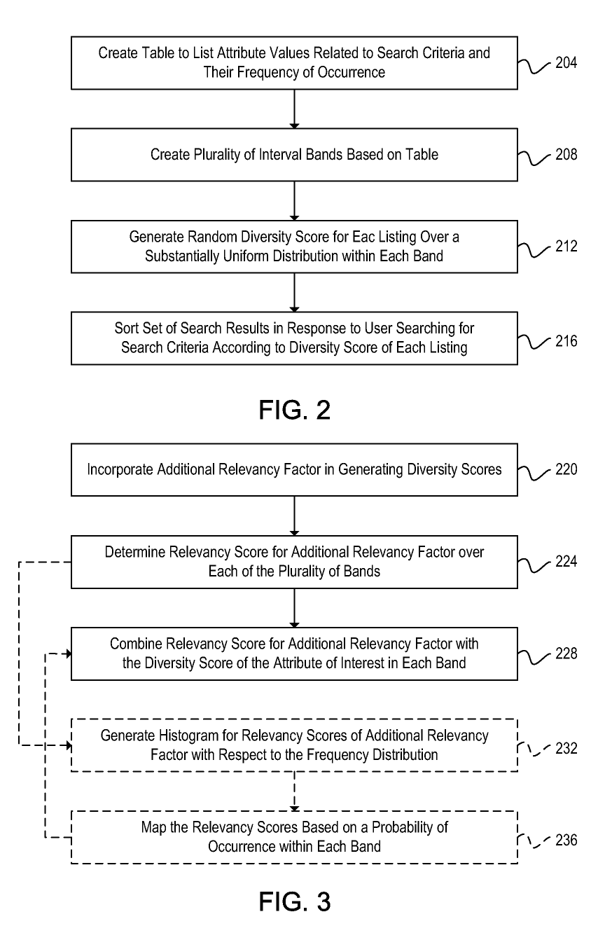

FIG. 2 is a flow chart of a method for generating diversified vertical search listings. At block 204, the diversity processing engine 130 lists attribute values related to search criteria and their frequency of occurrence to create a plurality of listings. At block 208, a plurality of interval bands are created based on the plurality of listings. At block 212, a random diversity score is created for each listing over a substantially uniform distribution within each of the plurality of bands. At block 216, a set of search results is sorted to create a diversified listing in response to a user searching for the search criteria, according to the diversity score of each listing.

FIG. 3 is a flow chart of a method for generating diversified vertical search listings when additional relevancy factors are incorporated. At block 220, the diversity processing engine 130 incorporates additional relevancy factors in generating the diversity scores (FIG. 2A) by incorporating the additional relevancy factor into the generated diversity scores. This is accomplished at blocks 224 and 228 by determining a relevancy score for the additional relevancy factor over each of the plurality of bands (block 224) and combining the relevancy score for the additional relevancy factor with the diversity score of the attribute of interest separately in each of the plurality of bands (block 228) to generate a plurality of newly calculated diversity scores across the plurality of bands. The sorting step of block 216 (FIG. 2A) may then be repeated at this point.

If a frequency distribution of the additional relevancy factor across the plurality of bands is not uniform, the diversity processing search engine 130, at block 232, generates a histogram for the relevancy scores of the additional relevancy factor with respect to the frequency distribution by, at block 236, mapping the relevancy scores based on a probability of occurrence within each of the plurality of bands. The histogram having the newly generated relevancy scores is then combined with respective diversity scores across the plurality of bands (block 228).

Various modifications, changes, and variations apparent to those of skill in the art may be made in the arrangement, operation, and details of the methods and systems disclosed. The embodiments may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware. Embodiments may also be provided as a computer program product including a machine-readable medium having stored thereon instructions that may be used to program a computer (or other electronic device) to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

1. A method of generating a diversified vertical search results listing, comprising:
listing attribute values related to search criteria and their frequency of occurrence to create a plurality of listings;
creating a plurality of interval bands based on the plurality of listings;
generating a random diversity score for each listing over a substantially uniform distribution within each of the plurality of bands; and
sorting a set of search results for diversified listing in response to a user searching for the search criteria according to the diversity score of each listing.

2. The method of claim 1, wherein the plurality of bands are defined based on a number of listings available for each respective attribute value in response to a search query that includes an attribute of interest.

3. The method of claim 2, further comprising:
including an additional relevancy factor in generating the diversity scores by incorporating the additional relevancy factor into the generated diversity scores.

4. The method of claim 3, wherein the additional relevancy factor is incorporated into the diversity scores through:
determining a relevancy score for the additional relevancy factor over each of the plurality of bands; and
combining the relevancy score for the additional relevancy factor with the diversity score of the attribute of interest separately in each of the plurality of bands to generate a plurality of newly calculated diversity scores across the plurality of bands.

5. The method of claim 4, wherein if a frequency distribution of the additional relevancy factor across the plurality of bands is not uniform, the method further comprises:
generating a histogram for the relevancy scores of the additional relevancy factor with respect to the frequency distribution by mapping the relevancy scores based on a probability of occurrence within each of the plurality of bands; and
combining the histogram with respective diversity scores across the plurality of bands.

6. The method of claim 5, wherein the histogram incorporates at least a third relevancy factor.

7. The method of claim 4, wherein the additional relevancy factor comprises at least one of a click through rate (CTR) and a brand popularity metric.

8. The method of claim 4, wherein the additional relevancy factor is incorporated into the diversity scores in real-time.

9. The method of claim 1, wherein sorting the set of search results is performed in advance of receiving a search query for the attribute of interest.

10. A method of generating a diversified vertical search results listing, comprising:
creating a table to list attribute values related to search criteria and their frequency of occurrence for an attribute of interest;
creating a plurality of interval bands based on a plurality of listings in the table;
generating a random diversity score for each listing over a substantially uniform distribution within each of the plurality of bands;
incorporating an additional relevancy factor into the generated diversity scores through:
determining a relevancy score for the additional relevancy factor over each of the plurality of bands; and
combining the relevancy score for the additional relevancy factor with the diversity score in each respective band to generate a plurality of calculated final diversity scores across the plurality of bands; and
sorting a set of search results for diversified listing in response to a user searching for the search criteria according to the final diversity score of each listing.

11. The method of claim 10, wherein if a frequency distribution of the additional relevancy factor across the plurality of bands is not uniform, the method further comprises:
generating a histogram for the relevancy scores of the additional relevancy factor with respect to the frequency distribution by mapping the relevancy scores based on a probability of occurrence within each of the plurality of bands; and
combining the histogram with respective final diversity scores across the plurality of bands to generate new diversity scores for use in sorting the set of search results.

12. The method of claim 11, wherein the histogram incorporates at least a third relevancy factor.

13. The method of claim 10, wherein the additional relevancy factor comprises at least one of a click through rate (CTR) and a historic level of user consumption.

14. The method of claim 10, wherein the additional relevancy factor is incorporated into the diversity scores in real-time.

15. A system to generate a diversified vertical search results listing, comprising a vertical search engine to process queries from a web site and to return results based on calculated relevancy scores;
a database to store statistical data on attribute values associated with attributes of interest related to the queries, and to store listings on the attributes of interest and corresponding descriptive text; and
a diversity processing engine coupled with the vertical search engine and with the database, wherein the diversity processing engine incorporates listings statistics from the database to calculate diversity scores that produce a diversified set of listings for at least some of the attributes of interest, wherein the diversity processing engine:
creates a table for listing attribute values related to search criteria and their frequency of occurrence;
creates a plurality of bands based on a plurality of listings in the table;
generates a random diversity score for each listing over a substantially uniform distribution within each of the plurality of bands; and
sorts a set of search results for diversified listing of the attribute of interest according to the diversity score of each respective listing.

16. The system of claim 15, wherein the database comprises a listings statistics database to store the statistical data on the attribute values, and a listings database to store the listings and related data.

17. The system of claim 15, wherein the diversity score of each attribute value is statistically combined with respective relevancy scores of each attribute value to produce revised diversity scores across the plurality of bands.

18. The system of claim 15, wherein the plurality of bands are defined based on a statistical frequency of listing respective attribute values when the attribute of interest is included in a search query without use of the diversity processing engine.

19. The system of claim 15, wherein the diversity processing engine includes an additional relevancy factor in generating the diversity scores by incorporating the additional relevancy factor into the generated diversity scores.

20. The system of claim 19, wherein the additional relevancy factor is incorporated into the diversity scores by the diversity processing engine, which:
determines a relevancy score for the additional relevancy factor over each of the plurality of bands; and
combines the relevancy score for the additional relevancy factor with the diversity score of the attribute of interest separately in each of the plurality of bands to generate a plurality of newly calculated diversity scores across the plurality of bands.

21. The system of claim 20, wherein if a frequency distribution of the additional relevancy factor across the plurality of bands is not uniform, the diversity processing engine generates a histogram for the relevancy scores of the additional relevancy factor with respect to the frequency distribution by mapping the relevancy scores based on a probability of occurrence within each of the plurality of bands, and combines the histogram with respective diversity scores across the plurality of bands.

22. The system of claim 21, wherein the histogram incorporates at least a third relevancy factor.

23. The system of claim 20, wherein the additional relevancy factor comprises at least one of a click through rate (CTR) and a brand popularity metric.

24. The system of claim 20, wherein the additional relevancy factor is incorporated into the diversity scores in real-time.

25. The system of claim 15, wherein the diversity processing engine sorts the set of search results for the diversified listing in advance of receiving a search query for the attribute of interest.
